(19) United States
(12) Patent Application Publication
(10) Pub. No.: US 2015/0019079 A1
(43) Pub. Date: Jan. 15, 2015

(54) METHOD OF INHIBITING AN AUTOMATIC ENGINE STOP DURING STEERING MANEUVER

(71) Applicant: GM GLOBAL TECHNOLOGY OPERATIONS LLC, Detroit, MI (US)

(72) Inventor: Roberto Romanato, Settimo Torinese (DE)

(21) Appl. No.: 14/321,502

(22) Filed: Jul. 1, 2014

(30) Foreign Application Priority Data
Jul. 1, 2013 (GB) 1311893.0

(51) Int. Cl. F02N 11/08; B60W 10/20; B60W 10/06

(52) U.S. Cl. CPC F02N 11/0818; B60W 10/06; B60W 10/20
USPC 701/41

(57) ABSTRACT

A method of inhibiting an automatic engine stop in an automotive system is disclosed. The automotive system includes a controller for automatically stopping and starting an internal combustion engine, and an electric steering system. An automatic engine stop is inhibited if a supply current (Iₛᵤₚₚₗ) for the electric steering system or if a change of the steering angle is detected during a steering maneuver.

### CROSS REFERENCE TO RELATED APPLICATION

This application claims priority to Great Britain Patent Application No. 1311893.0 filed Jul. 1, 2013, which is incorporated herein by reference in its entirety.

### TECHNICAL FIELD

The present disclosure relates to a method of inhibiting an automatic engine stop or autostop during a steering maneuver in automotive system having a controller, with or without hybrid architecture, and configured to stop and start the internal combustion engine (ICE or simply engine).

### BACKGROUND

It is known that automotive system are provided with a controller, normally an electronic control unit (ECU), which is configured to perform, among other functions, the so called “Stop & Start” (or simply S/S) function. By using this function, the ECU automatically shuts down and restarts the engine to reduce the amount of time the engine spends idling, thereby reducing fuel consumption and emissions.

It has to be considered that one of the challenges in fuel economy walk down consists in increasing the engine stop time during the homologation cycle. To reach this target new Stop & Start strategies are under investigation and, therefore, car manufacturers are trying to increase the speed threshold for an automatic engine stop to intervene. Actually, this threshold is normally included in the range 0-1 m/s, but the tendency is to increase it. The impact of the new tendency leads to the fact that an automatic engine stop condition can arise during a steering manoeuver, such as parking or approaching a crossroads, if the vehicle speed threshold for an automatic engine stop to intervene is higher than 0 m/s.

The patent application DE102011004046A1 discloses a device having a microcomputer (11) for stopping and starting a combustion engine when predetermined autostop and autostart conditions are satisfied. Among these conditions, a predetermined threshold for the steering angle is defined. Therefore, this method requires additional sensors (e.g. to measure the steering angular position) with consequent cost increase, reliability decrease and a more complex control system.

Therefore a need exists for a new method of inhibiting an automatic engine stop during a steering maneuver in automotive system provided with a “Stop & Start” function, the method being successful if no additional sensors are required. An object of an embodiment of the present disclosure is to provide a more reliable “Stop & Start” function during a steering maneuver in an automotive system provided with a controller configured to stop and start the ICE and an electric steering system.

### SUMMARY

An embodiment of the disclosure provides a method of inhibiting an automatic engine stop in an automotive system provided with a controller, for automatically stopping and starting an internal combustion engine, and an electric steering system, wherein an automatic engine stop is inhibited if a supply current for the electric steering system is detected or if a change of the steering angle is detected during a steering maneuver. Consequently, an apparatus is disclosed for inhibiting an automatic engine stop, the apparatus including means for inhibiting the automatic engine stop and means for detecting a supply current for the electric steering system or a change of the steering angle, during a steering maneuver. An advantage of this embodiment is that the inhibition of an undesired autostop during a steering maneuver is linked to the supply current which is required by the steering electric motor or to a change of the steering angle, being such information already available by the Electronic Stability Program.

According to another embodiment, the inhibition of the automatic engine stop is actuated when the supply current is higher than a current threshold and a time interval, during which this condition is true, is within a range. Consequently, the means for inhibiting the automatic engine stop are configured for actuating said inhibition if the supply current is higher than a current threshold and a time interval, during which this condition is true, is within a range. In order not to take into account false signals, an advantage of this embodiment consists in that both the value of the electric current and the time interval during which the electric current is supplied are monitored.

According to an aspect of this embodiment, the time interval ranges between 0.1 s and 2 s. Consequently, the means for inhibiting the automatic engine stop is configured for actuating said inhibition if said time interval ranges between 0.1 s and 2 s. An advantage of this aspect is that the time interval of the supply current is monitored in a way to avoid either noises or further causes of the strong current absorption. In fact, if the current is present for less than 0.1 s, this is only a disturbance, while if the current takes more than 2 s, this long period during which a high current value is supplied cannot be due to the steering system, since it works with current pulses and not with steady currents.

According to a further embodiment, the supply current is a difference between an unfiltered supply current and a filtered supply current. Consequently, the means for detecting a supply current are configured for detecting it as a difference between an unfiltered supply current and a filtered supply current. An advantage of this embodiment is that it cuts false signals, as disturbances or noises.

According to an aspect of this embodiment, said filtered supply current is obtained by applying a low-pass filter or a moving average filter to the unfiltered supply current. Consequently, the apparatus further includes means for applying a low-pass filter or a moving average filter to the unfiltered supply current. An advantage of this aspect is to use for the current filtering, well known electronic filters.

According to a still further embodiment, the automatic engine stop is inhibited by activating a latch. Consequently, the apparatus for inhibiting an automatic engine stop also includes means for activating a latch. An advantage of this embodiment is that, activating a latch, it is possible to maintain the inhibition also when the required supply current is over but the steering maneuver is not yet completely ended.

According to an aspect, said latch is deactivated when a speed of the automotive system is higher than a predetermined speed threshold. Consequently, the apparatus for inhibiting an automatic engine stop also includes means for deactivating a latch when a speed of the automotive system is higher than a predetermined speed threshold. An advantage of this aspect is that the condition to reset the latch and, consequently, to enable again an automatic engine stop, is linked to the speed of the automotive system, which must be higher than a predetermined threshold, thus ensuring that the steering maneuver is definitely ended. This condition also covers the case when the driver changes his mind and does not want to stop the vehicle anymore.

According to still another embodiment, the method further compares a battery current with a battery current threshold and inhibits the automatic engine stop whenever said battery current is lower than said battery current threshold. Consequently, the apparatus for inhibiting an automatic engine stop also includes means for comparing a battery current with a battery current threshold and means for inhibiting the automatic engine stop whenever said battery current is lower than said battery current threshold. This further check provides an alternative condition for inhibiting an automatic engine stop, whenever the battery current is low and could be insufficient for the starter activation.

According to a different embodiment, said supply current is measured by a battery sensor. Consequently, the means for detecting the supply current are configured for detecting a supply current, which is measured by a battery sensor. An advantage of this embodiment is that the method does not require any further sensor, since the so called “intelligent” battery sensor is already available in automotive system provided with the Stop & Start function and/or hybrid powertrain. This battery sensor is already needed for monitoring voltage, current and temperature of the battery, thus determining its state of charge.

The method according to one of its aspects can be carried out with the help of a computer program including a program-code for carrying out all the steps of the method described above, and in the form of computer program product including the computer program. The computer program product can be embedded in a control apparatus for an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

### BRIEF DESCRIPTION OF THE DRAWINGS

The present disclosure will hereinafter be described in conjunction with the following drawing figures, wherein like numerals denote like elements, and:

FIG. 1 schematically represents a hybrid powertrain of a motor vehicle;

FIG. 2 is a scheme of the hardware, which is needed to perform the Stop and Start function for automotive systems;

FIG. 3 is a graph depicting the vehicle speed, the battery current, which is required during a steering maneuver, and the automatic engine stop disable signal;

FIG. 4 is a block diagram of the method of inhibiting an automatic engine stop, according to an embodiment of the present disclosure; and

FIG. 5 is a high level flowchart of the method as in the block diagram of FIG. 4.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

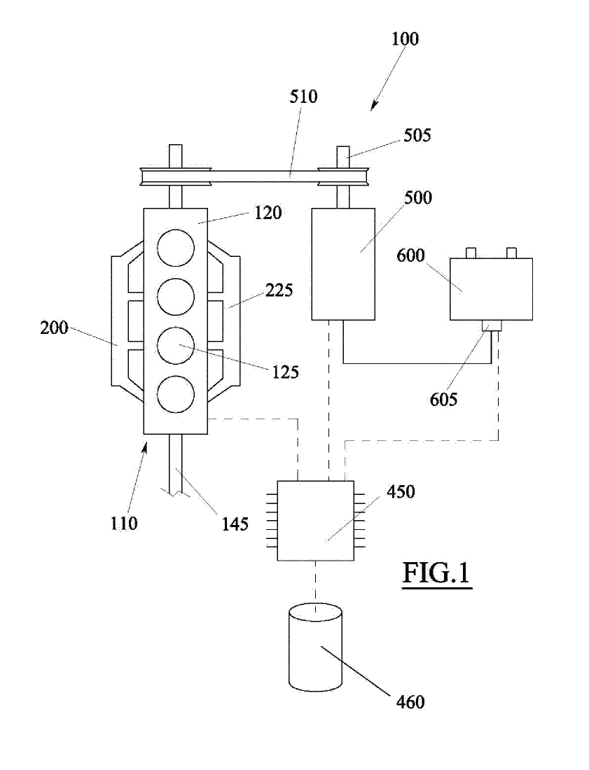

Some embodiments may include a motor vehicle's hybrid powertrain 100 (or, generally, an automotive system 100), as shown in FIG. 1, that includes an internal combustion engine (ICE) 110, in this example a diesel engine, a transmission (a manual transmission 510 in the example of FIG. 1), a motor-generator electric unit (MGU) 500, an electric energy storage device (battery) 600 electrically connected to the MGU 500, and an electronic control unit (ECU) 450. The hybrid powertrain architecture has at least a direct electric drive axle, the rear axle 520 in the example of FIG. 1. The ICE 110 includes at least an engine block 120 defining at least one cylinder 125, a crankshaft 145, an intake manifold 200 and an exhaust manifold 225.

The MGU 500 is an electric machine, namely an electro-mechanical energy converter, which is able either to convert electricity supplied by the battery 600 into mechanical power (i.e., to operate as an electric motor) or to convert mechanical power into electricity that charges the battery 600 (i.e., to operate as electric generator). In greater details, the MGU 500 may include a rotor, which is arranged to rotate with respect to a stator, in order to generate or respectively receive the mechanical power. The rotor may include means to generate a magnetic field and the stator may include electric windings connected to the battery 600, or vice versa. If the MGU 500 operates as electric motor, the battery 600 supplies electric currents in the electric windings, which interact with the magnetic field to set the rotor in rotation. Conversely, when the MGU 500 operates as electric generator, the rotation of the rotor causes a relative movement of the electric wiring in the magnetic field, which generates electric currents in the electric windings. The MGU 500 may be of any known type, for example a permanent magnet machine, a brushed machine or an induction machine. The MGU 500 may also be either an asynchronous machine or a synchronous machine.

The rotor of the MGU 500 may include a coaxial shaft 505, which is mechanically is connected with other components of the hybrid powertrain 100, so as to be able to deliver or receive mechanical power to and from the final drive of the motor vehicle. In this way, operating as an electric motor, the MGU 500 can assist or replace the ICE 110 in propelling the motor vehicle, whereas operating as an electric generator, especially when the motor vehicle is braking, the MGU 500 can charge the battery 600. In the present example, the MGU shaft 505 is connected with the ICE crankshaft 145 through a transmission belt 510, similarly to a conventional alternator starter. In order to switch between the motor operating mode and the generator operating mode, the MGU 500 may be equipped with an appropriate internal control system.

The hybrid powertrain 100 may further include an electronic control unit (ECU) 450 in communication with one or more sensors and/or devices associated with the ICE 110 and equipped with a memory system 460. The ECU 450 may receive input signals from various sensors configured to generate the signals in proportion to various physical parameters associated with the ICE 110 and the MGU 500.

Turning now to the ECU 450, this apparatus may include a digital central processing unit (CPU) in communication with the memory system 460 and an interface bus. The memory system 460 may include various storage types including optical storage, magnetic storage, solid state storage, and other non-volatile memory. The interface bus may be configured to send, receive, and modulate analog and/or digital signals to/from the various sensors and control devices. The CPU is configured to execute instructions stored as a program in the memory system 460, and send and receive signals to/from the interface bus. The program may embody the methods disclosed herein, allowing the CPU to carryout out the steps of such methods and control the ICE 110 and the MGU 500.

In order to carry out these methods, the ECU 450 is in communication with one or more sensors and/or devices associated with the ICE 110, the MGU 500 and the battery 600. The ECU 450 may receive input signals from various sensors configured to generate the signals in proportion to various physical parameters associated with the ICE 110, the MGU 500 and the battery 600.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

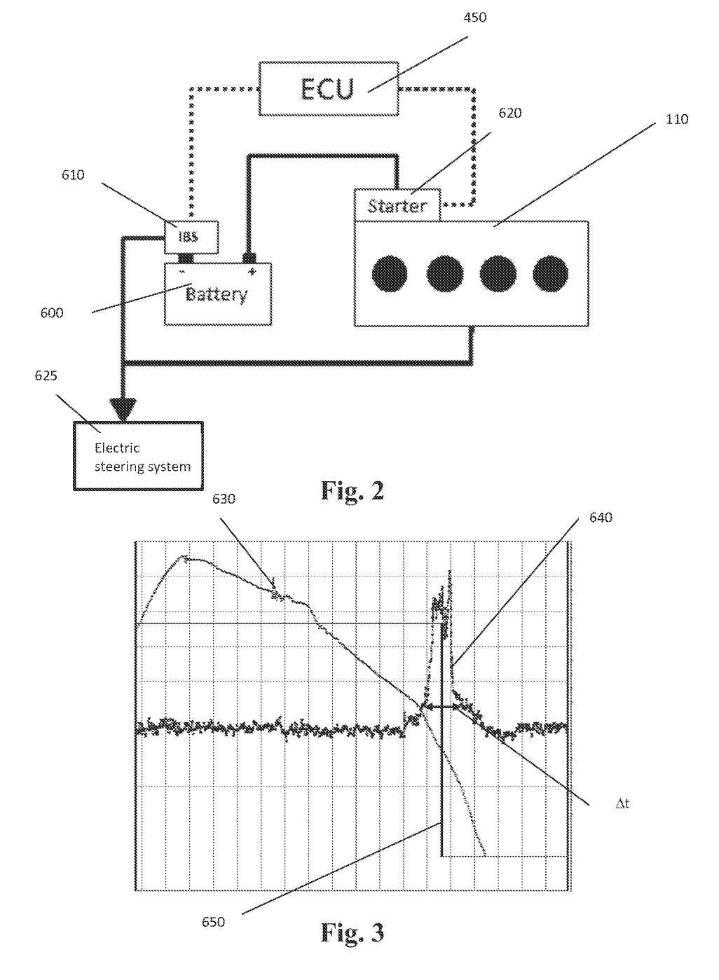

The present disclosure discloses a method of inhibiting an automatic engine stop during a steering maneuver in automotive systems provided with a controller (i.e., an ECU) 450 configured to stop and start the ICE and an electrically powered steering system 625, the method not requiring any additional sensor. In fact, as shown in FIG. 2, automotive systems, provided with a S/S system, already have a so called “intelligent” battery sensor (IBS) 610. This battery sensor monitors several functional parameters of the battery 600, like voltage, current, temperature. All these parameters are used to determine the battery state of charge, which is a mandatory information for the activation of a Stop & Start and/or for the MGU 500, if available. In fact the IBS 610 will transfer its information to the ECU 450, which will actuate the starter 620 to restart the ICE 110.

The present disclosure is based on the fact that during a steering maneuver, there is an inrush current to supply power to the electric steering system 625. In fact, such steering system uses an electric motor to assist the driver of a vehicle. Sensors detect the position and the torque of the steering column, and a computer module applies assistive torque via the electric motor, which connects to either the steering gear or steering column. Therefore, the idea of the present method is to detect, by means of the already available IBS sensor 610, the supply current Iₛᵤₚₚₗ, due to the steering system request, and, consequently, to inhibit the automatic engine stop.

As an alternative, if a change of the steering angle is detected, the automatic engine stop can be inhibited as well. The detection of the steering angle is made by means of a steering sensor which transmits its measurement to a controller of the automotive system. Such a controller can be integrated in the MGU or separated but in communication with the MGU. The controller performs the so called Electronic Stability Program (ESP) and therefore the information about the steering angle is already on the CAN bus.

FIG. 3 depicts a graph of the vehicle speed 630 vs. time, when the vehicle is slowing down, for example because involved in a parking maneuver or when approaching a crossroads. In the same graph, also the supply current 640 for the steering system is shown, when a steering maneuver is performed, and the autostop disable signal 650, which is a 0-1 function. As can be seen, there is an incremental supply current during the steering maneuver. The present method shall recognize such inrush current and the time interval Δt during which the current is supplied, to inhibit the autostop.

Up to now, the S/S control inhibits the automatic engine stop only for high constant current load, just to avoid battery discharge during the automatic engine stop phase. This check makes engine cycling decisions based on the current that is currently being discharged from the 12V battery. Typically, the engine needs to be on when too much current is being drawn from the battery.

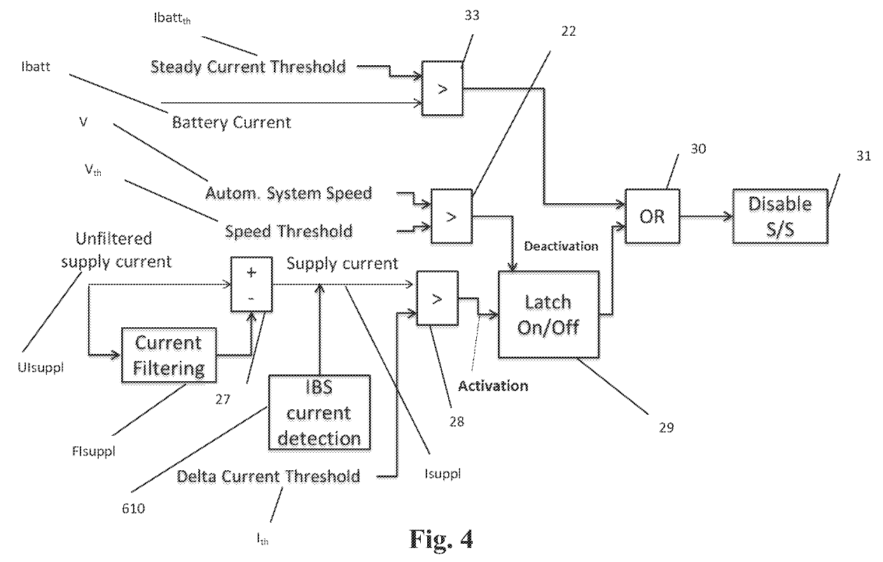

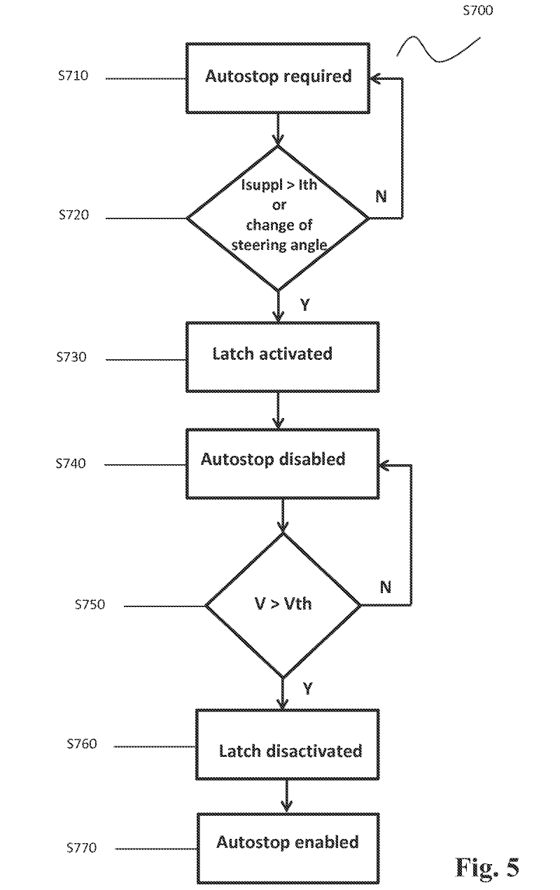

As can be seen in FIG. 4, according to an embodiment of the present method, a latch is introduced on the current load, so in case of current load pulse, the autostop should be inhibited for a time interval, in order to avoid autostop during the steering maneuver. More in detail, with reference to the same FIG. 4, the method compares 28 the difference 27 between the unfiltered supply current UIₛᵤₚₚₗ and a filtered supply current FIₛᵤₚₚₗ to a calibrated current threshold Iₜₕ. The inhibition of an undesired automatic engine stop during a steering maneuver is linked to the battery current which is required by the steering servomotor and said supply current is filtered, as an example by means of low-pass filter or moving average filter. These are electronic filters, the first passes low-frequency signals and attenuates signals with frequencies higher than the cutoff frequency; the latter is optimal for reducing random noise while retaining a sharp step response.

Then a latch is activated 29. In electronics, a flip-flop or latch is a circuit that has two stable states and can be used to store state information. The circuit can be made to change state by signals applied to one or more control inputs and will have one or two outputs. It is the basic storage element in sequential logic. Flip-flops and latches are a fundamental building block of digital electronics systems used in computers, communications, and many other types of systems. In our case the latch is used to disable 31 the Stop & Start function whenever said supply current Iₛᵤₚₚₗ is higher than 28 the current threshold Iₜₕ. Furthermore, the latch allows maintaining the inhibition of the engine stop also when the required supply current is over but the steering maneuver is not yet ended.

In order not to take into account false signals, also the time interval Δt of the battery current is monitored and the Stop & Start function is disabled if the time interval Δt is included in a predetermined range. Advantageously, time interval Δt ranges between 0.1 s and 2 s. This means that the time interval Δt of the supply current Iₛᵤₚₚₗ is monitored in a way to avoid either noises or further causes of the strong current absorption. In fact, if the current is present for less than 0.1 s, this is only a disturbance, while if the current takes more than 2 s; this long period of strong current request cannot be due to the steering system.

As already said, the latch will maintain the autostop disabled until a deactivation 29 of the latch is performed and this will happen when the automotive system speed V will be higher than 22 a predetermined speed threshold Vₜₕ. In fact, the condition to deactivate 29 the latch and, consequently, to enable again an autostop, is linked to the speed V of the automotive system 100, which must be higher than 22 a predetermined speed threshold Vₜₕ, thus ensuring that the steering maneuver is definitely ended.

Of course, the method further compares 33 the battery current Ibatt to a calibrated battery current threshold Ibattₜₕ and disables 31 the Stop & Start function whenever said battery current Ibatt is lower than said current threshold Ibattₜₕ. That is to say, the present method also performs an already known control, which will be an alternative condition for inhibiting an autostop, whenever the current, which the battery can supply for driving all types of electric consumers, is low and could be insufficient for the starter activation.

As mentioned, the battery current is provided by the battery sensor 610 and from which a filtered current value FIₛᵤₚₚₗ is subtracted 27. In other words, the present method does not require any further sensor, since the “intelligent” battery sensor is already available in automotive system provided with the Stop & Start function and/or in hybrid powertrain.

Summarizing, FIG. 5 shows a high level flowchart S700, depicting the described method. Whenever an automatic engine stop (or autostop) is required S710, if a supply current Iₛᵤₚₚₗ for the electric steering system 625 or if a change of the steering angle is detected S720 during a steering maneuver, a latch is activated S730 and the automatic engine stop is inhibited S740. The latch will stay active until the speed V of the automotive system 100 will become higher than S750 a speed threshold Vₜₕ. In such case, the latch will be deactivated S760 and the automatic engine stop will be enabled S770 again.

The present method allows the following benefits: increasing the driving feeling, avoiding automatic engine stop during undesired conditions, like steering maneuver; keep same CO2 benefit on homologation cycle, by increasing the vehicle speed for an autostop to be executed, without safety risks; increasing starter, Dual Mass Flywheel and battery durability.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-12. (canceled)

13. A method of inhibiting an automatic engine stop in an automotive system provided with a controller for automatically stopping and starting an internal combustion engine, and an electric steering system comprising inhibiting an automatic engine stop when at least one of the following conditions exists: (i) a supply current for the electric steering system is within a first predefined range or (ii) a change of the steering angle is detected during a steering maneuver.

14. The method according to claim 13, wherein the inhibition of the automatic engine stop is actuated when the supply current (Isuppl) is higher than a current threshold (Iₜₕ) and a time interval (Δt), during which this condition is true, is within a second predefined range.

15. The method according to claim 14, wherein said time interval (Δt) ranges between 0.1 s and 2 s.

16. The method according to claim 13, wherein said supply current (Isuppl) is a difference between an unfiltered supply current (UIsuppl) and a filtered (FIsuppl) supply current.

17. The method according to claim 16, wherein said filtered (FIsuppl) supply current is obtained by applying a low-pass filter to the unfiltered supply current (UIsuppl).

18. The method according to claim 16, wherein said filtered (FIsuppl) supply current is obtained by applying a moving average filter to the unfiltered supply current (UIsuppl).

19. The method according to claim 13, wherein the automatic engine stop is inhibited by activating a latch.

20. The method according to claim 19, wherein said latch is deactivated when a speed (V) of the automotive system is higher than a speed threshold (Vₜₕ).

21. The method according to claim 13 further comprises comparing a battery current (Ibatt) with a battery current threshold (Ibattₜₕ) and inhibiting the automatic engine stop whenever said battery current (Ibatt) is lower than said battery current threshold (Ibattₜₕ).

22. The method according to claim 13 wherein said supply current (Isuppl) is measured by a battery sensor.

23. A non-transitory computer program comprising a computer-code suitable for performing the method according to claim 13.

24. Computer program product on which the non-transitory computer program according to claim 23 is stored.

25. A control apparatus for an internal combustion engine, comprising an electronic control unit, a memory system associated to the electronic control unit and a non-transitory computer program according to claim 23 stored in the memory system.
